(19) United States
(12) Patent Application Publication
(10) Pub. No.: US 2017/0204128 A1
(43) Pub. Date: Jul. 20, 2017

(54) METHOD FOR PREPARING TRANSITION METAL COMPLEX

(71) Applicant: SABIC SK NEXLENE COMPANY PTE. LTD., Singapore (SG)

(72) Inventors: Yonggyu HAN, Daejeon (KR); Sun Young KIM, Daejeon (KR); Dong Cheol SHIN, Daejeon (KR); Sang Ick LEE, Daejeon (KR); Ki Nam CHUNG, Daejeon (KR); Sung Seok CHAE, Daejeon (KR)

(21) Appl. No.: 15/313,898

(22) PCT Filed: May 26, 2015
(86) PCT No.: PCT/KR2015/005240

§ 371 Date: Nov. 23, 2016

(30) Foreign Application Priority Data
May 28, 2014 (KR) 10-2014-0064671
May 21, 2015 (KR) 10-2015-0070877

(51) Int. Cl. C07F 17/00; C08F 210/16

(52) U.S. Cl. CPC C07F 17/00; C08F 210/16

(57) ABSTRACT

The present invention relates to a method for preparing a transition metal complex for the preparation of an olefin copolymer, and more specifically, to a method for preparing a transition metal complex comprising: a transition metal of Group 4 in the periodic table; a cyclopentadienyl ligand; and at least one phenolic ligand capable of being purified by sublimation or a simple filtration, wherein a halogen, in particular chlorine, is not included in the preparation of the transition metal complex.

### TECHNICAL FIELD

The present invention relates to a method for preparing a transition metal complex for preparation of an olefin copolymer, and more specifically, to a method for preparing a transition metal complex including: a transition metal of Group 4 in the periodic table; a cyclopentadienyl ligand; and at least one phenolic ligand capable of being purified by sublimation or a simple filtration, wherein chlorine is not included in the preparation of the transition metal complex.

### BACKGROUND ART

Transition metal complexes of Group 4 (IV) in the periodic table have been widely used as transition metal catalysts for preparing polyethylene. In particular, the transition metal complex including cyclopentadiene has been used to prepare various polymers, and is synthesized by methods already known in the art, using phenolic ligands. For the quantitative injection of a catalyst having activity in the process for preparing a polymer, management and identification of foreign substances are significantly important when preparing the catalyst so as to control denatured species having inactivity. In particular, due to a characteristic of the transition metals of Group 4 (IV) in the periodic table which is sensitive to moisture, management of the denatured species due to moisture is strictly performed.

Further, for the quantitative injection of a transition metal catalyst, it is significantly important to remove a residual ligand in the preparation process. When a remaining amount of a residual phenol organic material is present in the transition metal complex, it is difficult to control a precise polymer reaction due to the occurrence of catalyst deformations and due to the difficulty in injecting a precise amount of the catalyst. The separation of the transition metal complexes of Group 4 (IV) in the periodic table and the phenolic ligands is generally performed by recrystallization. However, a technology of a more effective purification method is required since the recrystallization may bring into an increase in the cost of the preparation process.

In addition, the management of a chlorine compound is strictly performed in a process for preparing polyethylene since the chlorine compound may corrode a material, and thus, special attention to management of a content of the chlorine compound in the catalyst should be paid.

Therefore, it is urgently required to develop a method for preparing a transition metal complex that does not include chlorine, capable of minimizing denatured species due to moisture and an effective removal a residual ligand, in the process of the catalyst preparation.

### RELATED ART DOCUMENT

### Non-Patent Documents

(Non-Patent Document 1) Inorg. Chem. 1989, 28(10), pp 2003-2007

(Non-Patent Document 2) J. Organomet. Chem. 1997, 544, pp 207-215

### DISCLOSURE

### Technical Problem

The present inventors made an effort to overcome the above-described problems according to the related art, and as a result, found that when a transition metal alkoxide precursor that does not include a halogen, particularly, chlorine, as a starting material, was reacted with a phenolic ligand capable of being purified by sublimation or a simple filtration, the formation of denatured species due to moisture could be minimized, and a transition metal complex that does not include chlorine was prepared, and then, completed the present invention.

An object of the present invention is to provide a method for preparing a transition metal complex by reacting a transition metal alkoxide precursor that does not include a halogen, particularly, chlorine, with a phenolic ligand capable of being purified by sublimation or a simple filtration.

### Technical Solution

On one general aspect, there provides a method for preparing a transition metal complex for preparation of an olefin copolymer, and more specifically, a method for preparing a transition metal complex represented by Chemical Formula 1 below by reacting a transition metal alkoxide precursor represented by Chemical Formula 2 below with a phenolic ligand represented by Chemical Formula 3 below, the transition metal complex including: a transition metal of Group 4 in the periodic table; a cyclopentadienyl ligand; and at least one phenolic ligand capable of being purified by sublimation or a simple filtration, wherein halogen, particularly, chlorine, is not included in preparation of the transition metal complex:

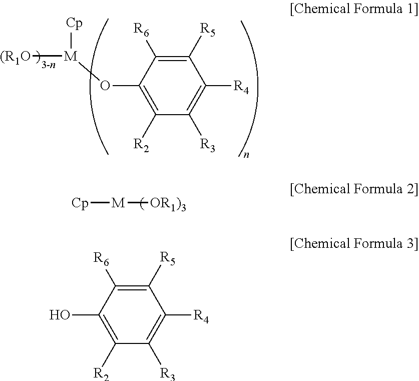

in Chemical Formulas 1, 2, and 3,

M is a transition metal of Group 4 in the periodic table;

Cp is a cyclopentadienyl ring which is a η⁵-bond to M, or a fused ring containing the cyclopentadienyl ring, the cyclopentadienyl ring or the fused ring containing the cyclopentadienyl ring may be further substituted with one or more selected from (C1-C20)alkyl, (C6-C30)aryl, (C2-C20)alkenyl, and (C6-C30)aryl(C1-C20)alkyl;

R₁ is (C1-C20)alkyl;

R₂, R₃, R₄, R₅, and R₆ are each independently hydrogen, halogen, (C1-C30)alkyl, (C6-C30)aryl, (C6-C30)aryl(C1-C30)alkyl, (C1-C30)alkyl(C6-C30)aryl, (C1-C30)alkoxy, (C6-C30)aryloxy or NR′R″, or R₂ and R₃, or R₅ and R₆ may be linked via (C2-C6)alkylene or (C2-C6)alkenylene to form a fused ring, respectively;

R′ and R″ are each independently (C1-C30)alkyl or (C6-C30)aryl; and

n is an integer of 1 to 3.

In the method for preparing a transition metal complex according to an exemplary embodiment of the present invention, the reaction may be performed under an organic solvent or by a neat reaction, wherein there is no limitation on kinds of organic solvents as long as it is able to dissolve the reaction materials.

In the method for preparing a transition metal complex according to an exemplary embodiment of the present invention, the reaction may be performed within a reflux temperature range of the solvent.

In the method for preparing a transition metal complex according to an exemplary embodiment of the present invention, a molar ratio of the transition metal alkoxide precursor represented by Chemical Formula 2 and the phenolic ligand represented by Chemical Formula 3 may be 1:1.1 to 3.5.

In the method for preparing a transition metal complex according to an exemplary embodiment of the present invention, R₂, R₃, R₅, and R₆ may be each independently hydrogen, halogen, (C1-C30)alkyl, (C6-C30)aryl, or R₂ and R₃, or R₅ and R₆ may be linked via (C2-C6)alkylene or (C2-C6)alkenylene to form a fused ring, respectively; R₄ may be hydrogen, halogen, (C1-C30)alkyl, (C1-C30)alkoxy, (C6-C30)aryloxy or NR′R″; and R′ and R″ may be each independently (C1-C30)alkyl or (C6-C30)aryl.

In the method for preparing a transition metal complex according to an exemplary embodiment of the present invention, a transition metal complex represented by Chemical Formula 4 below may be prepared by mixing the transition metal alkoxide precursor represented by Chemical Formula 2 below and the phenolic ligand represented by Chemical Formula 3 below:

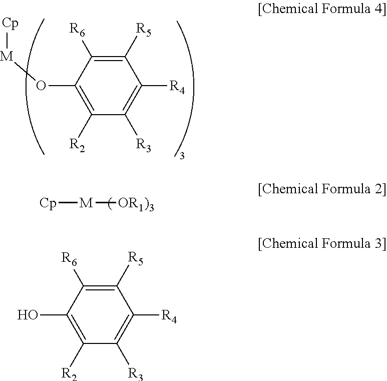

in Chemical Formulas 2, 3, and 4,

M is a transition metal of Group 4 in the periodic table;

Cp is a cyclopentadienyl ring which is a η⁵-bond to M, or a fused ring containing the cyclopentadienyl ring, the cyclopentadienyl ring or the fused ring containing the cyclopentadienyl ring may be further substituted with one or more selected from (C1-C20)alkyl, (C6-C30)aryl, (C2-C20)alkenyl, and (C6-C30)aryl(C1-C20)alkyl;

R₁ is (C1-C20)alkyl;

R₂ and R₆ are each independently hydrogen, halogen, (C1-C20)alkyl or (C6-C20)aryl;

R₃ and R₅ are each independently hydrogen or halogen;

R₂ and R₃, or R₅ and R₆ may be linked via (C2-C6)alkylene or (C2-C6)alkenylene to form a fused ring; and

R₄ is hydrogen, halogen, (C1-C20)alkyl, (C1-C20)alkoxy, or di(C1-C20)alkylamino.

In the method for preparing a transition metal complex according to an exemplary embodiment of the present invention, a molar ratio of the transition metal alkoxide precursor represented by Chemical Formula 2 and the phenolic ligand represented by Chemical Formula 3 may be 1:3.0 to 3.5.

In the method for preparing a transition metal complex according to an exemplary embodiment of the present invention, the transition metal complex represented by Chemical Formula 4 may be a transition metal complex selected from the following structures:

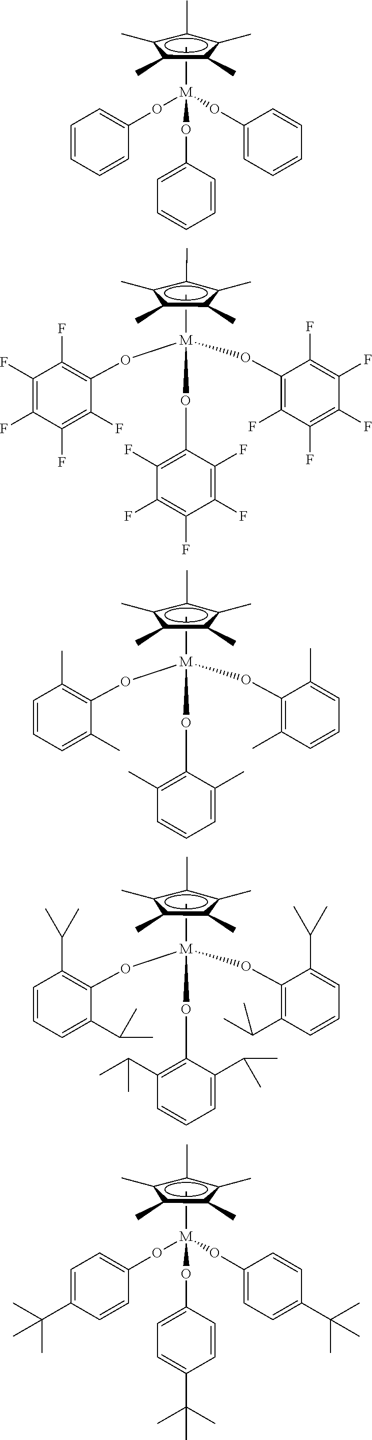

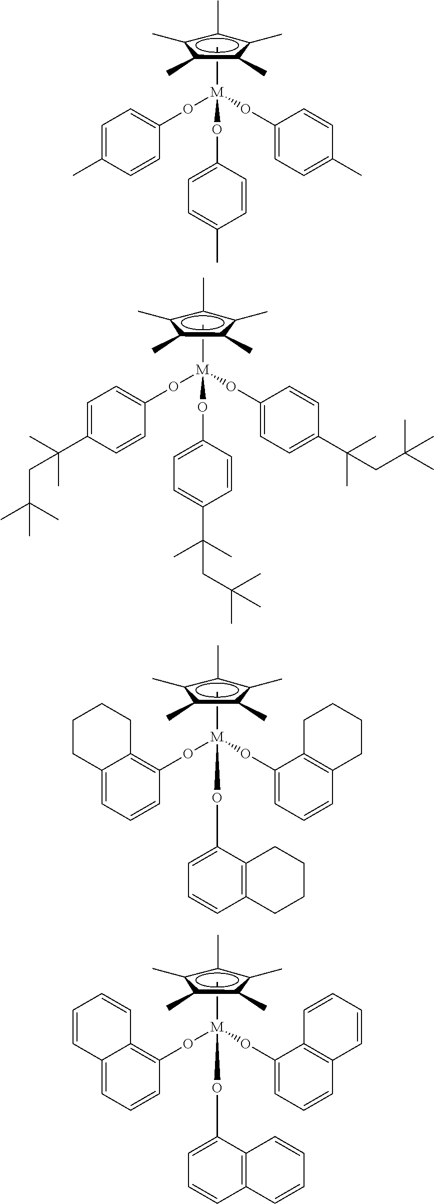

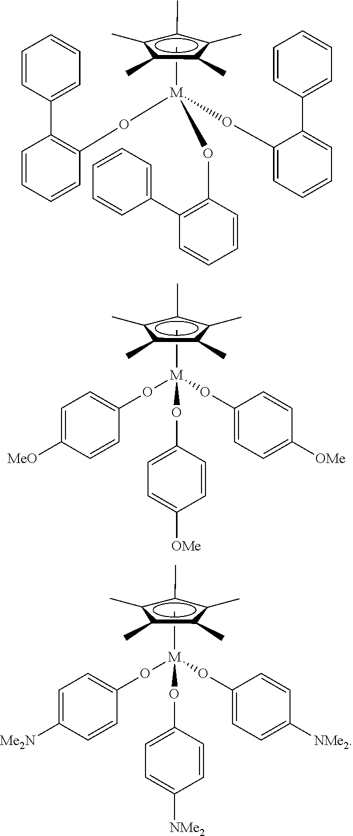

The method for preparing a transition metal complex according to an exemplary embodiment of the present invention may further include: purification by sublimation or a simple filtration in order to remove unreacted phenolic ligand after the reacting of the transition metal alkoxide precursor represented by Chemical Formula 2 and the phenolic ligand represented by Chemical Formula 3.

### Advantageous Effects

The method for preparing a transition metal complex according to the present invention includes the reaction of a transition metal alkoxide precursor that does not include a halogen, particularly, chlorine, as a starting material, with a phenolic ligand capable of being purified by sublimation or a simple filtration, thereby preparing the transition metal complex at a high yield, and thus, formation of denatured species due to moisture which is a problem according to the related art may be minimized, and simultaneously, the prepared transition metal complex and unreacted phenolic ligand may be simply purified through the sublimation or the simple filtration.

In addition, since the halogen, particularly, chlorine, is not included at all in the process of preparing the transition metal complex, there is no concern about the corrosion of a material during the process even though the prepared transition metal complex is used for olefin polymerization. Further, a transition metal chloride precursor which is a starting material used in the related art has a problem in that a product and an amine residue coexist since the transition metal chloride precursor is necessarily used together with an amine-based compound. However, the present invention using the transition metal alkoxide precursor which is not chloride as the starting material has an advantage in that impurities such as the amine residue do not coexist with the product.

Further, the present invention has a good reaction selectivity in that the transition metal complex combined with 1, 2, or 3 equivalent(s) of phenolic ligand(s) is capable of being easily prepared only by a change in a molar ratio of reaction materials.

### DESCRIPTION OF DRAWINGS

FIG. 1 illustrates ¹H-NMR data of Cp*Ti(OMe)₃.

FIG. 2 illustrates ¹H-NMR data of Cp*Ti(iOPr)₃.

FIG. 3 illustrates ¹H-NMR data before sublimation in a reaction of Cp*Ti(OMe)₃ and 4-t-octylphenol (3.1 eq.).

FIG. 4 illustrates ¹H-NMR data after sublimation in a reaction of Cp*Ti(OMe)₃ and 4-t-octylphenol (3.1 eq.).

FIG. 5 illustrates ¹H-NMR data after sublimation in a reaction of Cp*Ti(iOPr)₃ and 4-t-octylphenol (3.1 eq.).

FIG. 6 illustrates ¹H-NMR data after a reaction of Cp*TiCl of Comparative Example 1 and 4-t-octylphenol (3.1 eq.).

FIG. 7 illustrates ¹H-NMIR data after a reaction of Cp*TiCl of Comparative Example 2, triethylamine (3.2 eq.), and 4-t-octylphenol (3.1 eq.).

### BEST MODE

The present invention relates to a method for preparing a transition metal complex for preparation of an olefin copolymer, and more specifically, to a method for preparing a transition metal complex represented by Chemical Formula 1 below by reacting a transition metal alkoxide precursor represented by Chemical Formula 2 below with a phenolic ligand represented by Chemical Formula 3 below, the transition metal complex represented by Chemical Formula 1 including: a transition metal of Group 4 in the periodic table; a cyclopentadienyl ligand; and at least one phenolic ligand capable of being purified by sublimation or a simple filtration.

The preparation method of the present invention is characterized by not including halogen, particularly, chlorine, as an impurity, in preparing the transition metal complex for preparation of an ethylene homopolymer or a copolymer of ethylene and α-olefin:

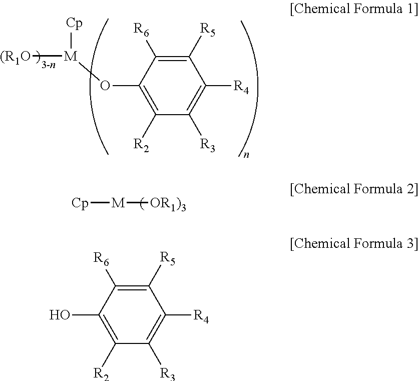

in Chemical Formulas 1, 2, and 3,

M is a transition metal of Group 4 in the periodic table;

Cp is a cyclopentadienyl ring which is a η⁵-bond to M, or a fused ring containing the cyclopentadienyl ring, the cyclopentadienyl ring or the fused ring containing the cyclopentadienyl ring may be further substituted with one or more selected from (C1-C20)alkyl, (C6-C30)aryl, (C2-C20)alkenyl, and (C6-C30)aryl(C1-C20)alkyl;

R₁ is (C1-C20)alkyl;

R₂, R₃, R₄, R₅, and R₆ are each independently hydrogen, halogen, (C1-C30)alkyl, (C6-C30)aryl, (C6-C30)aryl(C1-C30)alkyl, (C1-C30)alkyl(C6-C30)aryl, (C1-C30)alkoxy, (C6-C30)aryloxy or NR′R″, or R₂ and R₃ or R₅ and R₆ may be linked via (C2-C6)alkylene or (C2-C6)alkenylene to form a fused ring, respectively;

R′ and R″ are each independently (C1-C30)alkyl or (C6-C30)aryl; and

n is an integer of 1 to 3.

The ‘alkyl’ includes all of the linear or branched carbon chains.

The transition metal complex represented by Chemical Formula 1 prepared in the present invention has a structure in which the cyclopentadienyl ligand and at least one aryloxide ligand are included around the transition metal of Group 4, and the ligands are not mutually cross-linked, which has a high activity even at a high temperature in preparing the ethylene homopolymer or the copolymer of ethylene and α-olefin.

In the Chemical Formula 1, the transition metal is any one as long as it is a transition metal of Group 4 in the periodic table, preferably titanium, zirconium or hafnium, and more preferably, titanium.

In the method for preparing a transition metal complex according to an exemplary embodiment of the present invention, the reaction may be performed under an organic solvent or by a neat reaction, wherein there is no limitation on the organic solvent as long as it is able to dissolve the reaction materials. The neat reaction refers to a reaction performed by mixing the transition metal alkoxide precursor represented by Chemical Formula 2 and the phenolic ligand represented by Chemical Formula 3 without using the organic solvent, which may be performed under vacuum.

It is preferred that the organic solvent may be selected from the group consisting of methylcyclohexane (MCH), hexane, methylene dichloride, toluene, cyclohexane, benzene and heptane to be used alone, or a mixed solvent of two or more thereof may be used, in consideration of solubility of a final compound, and more preferably, methylcyclohexane (MCH) or toluene.

In the method for preparing a transition metal complex according to an exemplary embodiment of the present invention, it is preferred that the reaction may be performed at the reflux temperature of the organic solvent. Then the reaction is performed at a temperature at around the reflux temperature of the organic solvent, a reaction to be desired may not be easily performed, and thus, the transition metal complex represented by Chemical Formula 1 may have a low yield, and other side reactions may occur.

In the method for preparing a transition metal complex according to an exemplary embodiment of the present invention, the transition metal alkoxide precursor represented by Chemical Formula 2 and the phenolic ligand represented by Chemical Formula 3 may be used in the same amount, or in an excessive amount. However, it is preferred that a molar ratio of the transition metal alkoxide precursor represented by Chemical Formula 2 and the phenolic ligand represented by Chemical Formula 3 is 1:1.1 to 3.5 in order to prevent various mixtures from being formed in which the number of ligands is different.

In the method for preparing a transition metal complex according to an exemplary embodiment of the present invention, it is preferred that R₂, R₃, R₅, and R₆ are each independently hydrogen, halogen, (C1-C30)alkyl, (C6-C30)aryl, or R₂ and R₃, or R₅ and R₆ may be linked via (C2-C6)alkylene or (C2-C6)alkenylene to form a fused ring, respectively; R₄ is hydrogen, halogen, (C1-C30)alkyl, (C1-C30)alkoxy, (C6-C30)aryloxy or NR′R″; and R′ and R″ are each independently (C1-C30)alkyl or (C6-C30)aryl

In the method for preparing a transition metal complex according to an exemplary embodiment of the present invention, the transition metal complex having three aryloxide ligands corresponding to a case where n is 3 in Chemical Formula 1 has a large steric hindrance to have a significantly high activity at a high temperature, which is able to prepare a polymer with high molecular weight and low density at a high yield, and thus, the transition metal complex having three aryloxide ligands corresponding to a case where n is 3 in Chemical Formula 1 is the most suitable as a highly active catalyst for preparation of an olefin copolymer.

In order to more preferably prepare the olefin polymer with high molecular weight and low density by having an excellent catalytic activity, a transition metal complex represented by Chemical Formula 4 below is prepared by reacting the transition metal alkoxide precursor represented by Chemical Formula 2 below and the phenolic ligand represented by Chemical Formula 3 below:

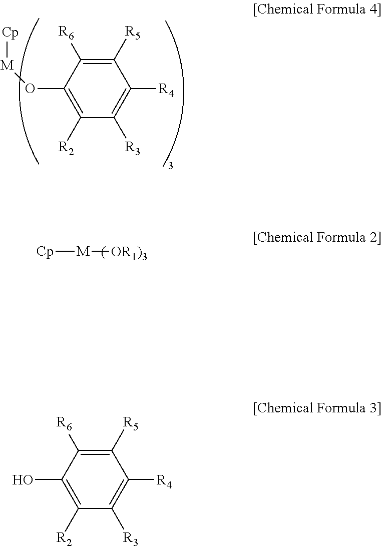

in Chemical Formulas 2, 3, and 4,

M is a transition metal of Group 4 in the periodic table;

Cp is a cyclopentadienyl ring which is a η5-bond to M, or a fused ring containing the cyclopentadienyl ring, the cyclopentadienyl ring or the fused ring containing the cyclopentadienyl ring may be further substituted with one or more selected from (C1-C20)alkyl, (C6-C30)aryl, (C2-C20)alkenyl, and (C6-C30)aryl(C1-C20)alkyl;

R₁ is (C1-C20)alkyl;

R₂ and R₆ are each independently hydrogen, halogen, (C1-C20)alkyl or (C6-C20)aryl;

R₃ and R₅ are each independently hydrogen or halogen;

R₂ and R₃, or R₅ and R₆ may be linked via (C2-C6)alkylene or (C2-C6)alkenylene to form a fused ring; and

R₄ is hydrogen, halogen, (C1-C20)alkyl, (C1-C20)alkoxy, or di(C1-C20)alkylamino.

The molar ratio of the transition metal alkoxide precursor represented by Chemical Formula 2 and the phenolic ligand represented by Chemical Formula 3 for preparing the transition metal complex represented by Chemical Formula 4 is 1:3.0 to 3.5, and preferably, 1:3.0 to 3.1.

Preferably, the transition metal complex represented by Chemical Formula 4 may be a transition metal complex selected from the following structures:

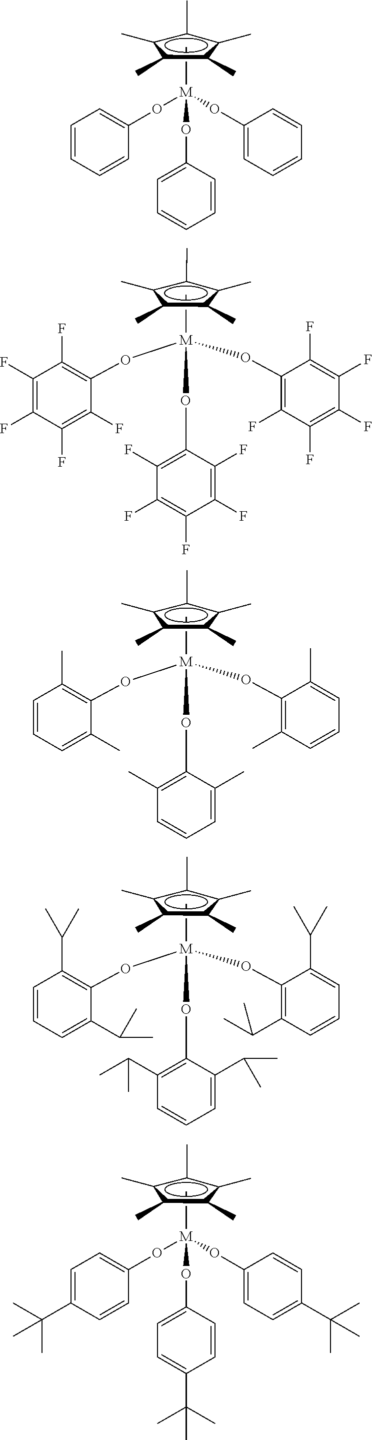

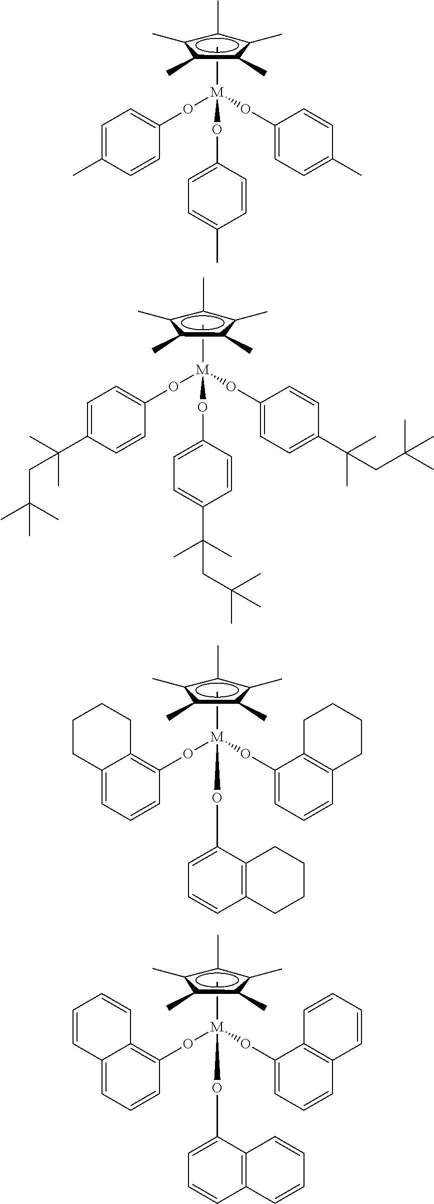

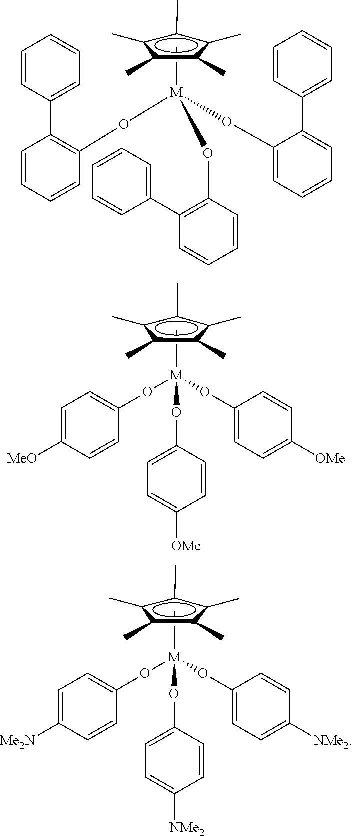

In order to improve the purity of the prepared transition metal complex represented by Chemical Formula 1, the method for preparing a transition metal complex according to an exemplary embodiment of the present invention may further include a process of removing unreacted residual phenolic ligand represented by Chemical Formula 2 from the transition metal complex represented by Chemical Formula 1 which is a product obtained after the reacting of the transition metal alkoxide precursor represented by Chemical Formula 2 and the phenolic ligand represented by Chemical Formula 3.

The process of removing the unreacted residual phenolic ligand represented by Chemical Formula 2 is to remove the unreacted residual phenolic ligand by sublimation or a simple filtration under a purification temperature of 100° C. to 130° C., and a low pressure condition of 0.1 to 2.0 torr. It is preferred that the process of removing the unreacted residual phenolic ligand is performed by the sublimation.

The transition metal complex prepared by the preparation method of the present invention may be used as a catalyst for olefin polymerization, and a method of the olefin polymerization may be any method known in the art.

The effects of the present invention are specifically described in the following Examples. However, the following Examples are merely described for illustrative purposes, and the scope of the present invention is not limited thereto.

All catalyst synthesis experiments were performed under a nitrogen atmosphere by using a standard Schlenk technology or a glove box technology, and the organic solvent used in the reaction was subjected to reflux under sodium metal and benzophenone to remove moisture, and distillation before use. ¹H-NMR analysis of the synthesized catalyst was performed by using a Bruker 500 MHz at room temperature.

Methylcyclohexane which is a polymerization solvent, was used by passing it through a tube filled with a molecular sieve of 5 Å and activated alumina, followed by bubbling with high purity of nitrogen so as to sufficiently remove moisture, oxygen, and other catalytic poison materials. The polymerized polymer was analyzed by a method described below.

### EXAMPLE 1

Preparation of Cp*Ti(4-t-octylphenolate)₃ using Cp*Ti(OMe)₃

(Pentamethylcyclopentadienyl)titanium(IV) trimethoxide (Cp*Ti(OMe)₃) (0.552 g, 1 eq.) and 4-t-octylphenol (1.238 g, 3.1 eq.) were mixed in a reaction vessel, and toluene (50 mL) was added thereto. A condenser was connected to the reaction vessel, and the reaction solution was stirred under reflux for 12 hours. When a color of the reaction solution turned from yellow to orange, toluene as a reaction solvent was slowly removed at 0.5 torr, and the reaction solution was heated at 110° C. to remove unreacted residual 4-t-octylphenol. Then, a temperature of a reactor was lowered to room temperature, and Cp*Ti(4-t-octylphenolate)₃ (in Chemical Formula 1, M is Ti, Cp is pentamethylcyclopentadienyl, n is 3, R₂, R₃, R₅, and R₆ are hydrogen, and R₄ is t-octyl) as an orange solid (1.62 g) was quantitatively obtained, which was confirmed by ¹H-NMR.

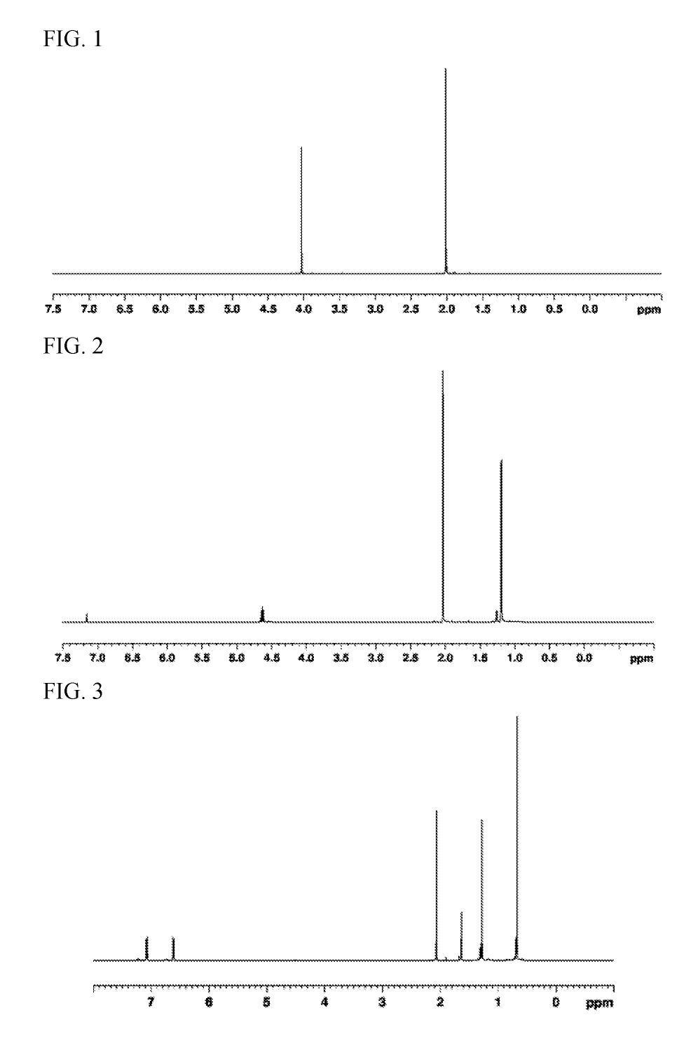

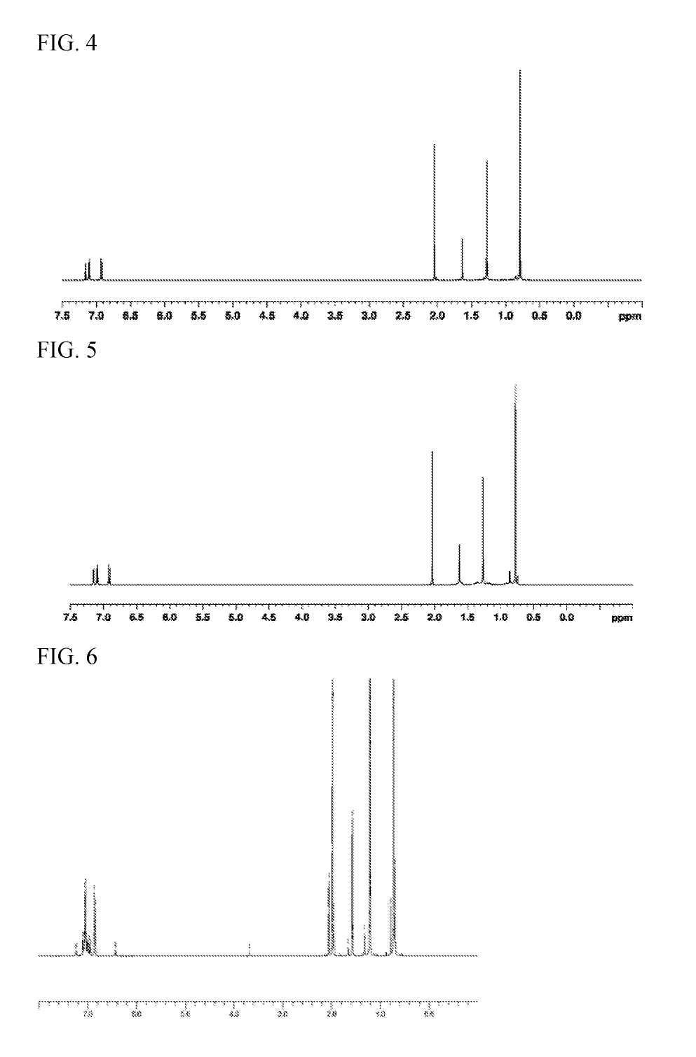

FIG. 1 illustrates ¹H-NMR data of Cp*Ti(OMe)₃, and FIGS. 3 and 4 illustrate ¹H-NMR data of the product, Cp*Ti(4-t-octylphenolate)₃ before and after the sublimation in the reaction of Cp*Ti(OMe)₃ and 4-t-octylphenol (3.1 eq.), respectively, which could be appreciated that the purity of the catalyst was increased after the sublimation as compared to that of the catalyst before the sublimation.

### EXAMPLE 2

### Preparation of Cp*Ti(4-t-octylphenolate)₃ using Cp*Ti(OiPr)₃

Cp*Ti(4-t-octylphenolate)₃ (1.62 g) was quantitatively obtained by performing the same reaction method as Example 1 except that (pentamethylcyclopentadienyl)titanium(IV) triisopropoxide (Cp*Ti(OiPr)₃) was used rather than using the (pentamethylcyclopentadienyl)titanium(IV) trimethoxide (Cp*Ti(OMe)₃).

FIG. 2 illustrates ¹H-NMR data of Cp*Ti(iOPr)₃, and FIG. 5 illustrates ¹H-NMR data of the product, Cp*Ti(4-t-Octylphenolate)₃ after the reaction of Cp*Ti(iOPr)₃ and 4-t-octylphenol (3.1 eq.) and the sublimation.

### EXAMPLE 3

### Preparation of Cp*Ti(phenolate)₃ using Cp*Ti(OMe)₃

(Pentamethylcyclopentadienyl)titanium(IV) trimethoxide (Cp*Ti(OMe)₃) (0.552 g, 1 eq.) and phenol (0.583 g, 3.1 eq.) were mixed in a reaction vessel, and methylcyclohexane (50 mL) was added thereto. A condenser was connected to the reaction vessel, and the reaction solution was stirred under reflux for 12 hours. It was confirmed that when a color of the reaction solution turned from yellow to orange, a solid was produced. Cp*Ti(phenolate)₃ (in Chemical Formula 1, M is Ti, Cp is pentamethylcyclopentadienyl, n is 3, and R₂, R₃, R₄, R₅, and R₆ are hydrogen) as an orange solid (0.95 g) was quantitatively obtained by a filtration, which was confirmed by ¹H-NMR and ¹³C-NMR.

¹H-NMR in CDl₃-d₁: δ=7.28 (2H, t), 7.01 (1H, d), 6.95 (2H, d), 2.18 (15H, s); ¹³C-NMR in CDCl₃-d₁: δ=157.3, 130.5, 130.1, 121.3, 115.9, 9.7

### EXAMPLE 4

### Preparation of Cp*Ti(phenolate)₃ using Cp*Ti(OiPr)₃

Cp*Ti(phenolate)₃ (0.95 g) was quantitatively obtained by performing the same reaction method as Example 3 except that (pentamethylcyclopentadienyl)titanium(IV) triisopropoxide (Cp*Ti(OiPr)₃) was used rather than using the (pentamethylcyclopentadienyl)titanium(IV) trimethoxide (Cp*Ti(OMe)₃).

### EXAMPLE 5

### Preparation of Cp*Ti(2,6-dimethylphenolate)₃using Cp*Ti(OMe)₃

Cp*Ti(2,6-dimethylphenolate)₃ (in Chemical Formula 1, M is Ti, Cp is pentamethylcyclopentadienyl, n is 3, R₃, R₅, and R₄ are hydrogen, and R₂ and R₆ are methyl) as an orange solid (1.12 g) was quantitatively obtained by performing the same reaction method as Example 3 except that 2,6-dimethyl phenol (0.79 g, 6.3 mmole) was used rather using the phenol, which was confirmed by ¹H-NMR and ¹³C-NMR.

¹H-NMR in CDCl₃-d₁: δ=6.99 (1H, m), 6.87 (2H, d), 2.18 (15H, s), 2.15 (18H, s); ¹³C-NMR in CDCl₃-d₁: δ=158.7, 130.5, 129.0, 126.0, 124.3, 15.4, 9.7

### EXAMPLE 6

### Preparation of Cp*Ti(2,6-diisopropylphenolate)₃ using Cp*Ti(OMe)₃

Cp*Ti(2,6-diisopropylphenolate)₃ (in Chemical Formula 1, M is Ti, Cp is pentamethylcyclopentadienyl, n is 3, R₃, R₅, and R₄ are hydrogen, and R₂ and R₆ are isopropyl) as an orange solid (1.43 g) was quantitatively obtained by performing the same reaction method as Example 3 except that 2,6-diisopropyl phenol (1.2 g, 6.3 mmole) was used rather using the phenol, which was confirmed by ¹H-NMR.

¹H-NMR in CDCl₃-d₁: δ=7.17 (2H, d), 7.07 (1H, m), 3.05 (1H, p), 2.18 (15H, s), 1.20 (36H, d); ¹³C-NMR in CDCl₃-d₁: δ=152.9, 137.7, 130.5, 124.7, 27.3, 23.6, 9.7

### EXAMPLE 7

### Preparation of Cp*Ti(2-phenylphenolate)₃using Cp*Ti(OMe)₃

Cp*Ti(2-phenylphenolate)₃ (in Chemical Formula 1, M is Ti, Cp is pentamethylcyclopentadienyl, n is 3, R₃, R₄, R₅, R₆ are hydrogen, and R₂ is phenyl) as an orange solid (0.83 g) was obtained at a yield (60%) by performing the same reaction method as Example 3 except that 2-phenyl phenol (1.12 g, 6.3 mmole) was used rather using the phenol, which was confirmed by ¹H-NMR.

¹H-NMR in CDCl₃-d₁: δ=7.62 (3H, d), 7.52 (12H, m), 7.41 (3H, m), 7.24 (3H, t), 7.10 (6H, m), 2.18 (15H, s); ¹³C-NMR in CDCl₃-d₁: δ=156.2, 137.9, 131.2, 130.5, 129.0, 127.9, 121.8, 116.4, 9.57

### EXAMPLE 8

### Preparation of Cp*Ti(1-naphtholate)₃ using Cp*Ti(OMe)₃

Cp*Ti(1-naphtholate)₃ (in Chemical Formula 1, M is Ti, Cp is pentamethylcyclopentadienyl, n is 3, R₄, R₅, and R₆ are hydrogen, and R₂ and R₃ are linked via buta-1,3-dienylene to form a ring) as an orange solid (0.81 g) was obtained at a yield (66%) by performing the same reaction method as Example 3 except that 1-naphthol (0.89 g, 6.3 mmole) was used rather using the phenol, which was confirmed by ¹H-NMR.

¹H-NMR in CDCl₃-d₁: δ=8.22 (3H, d), 8.10 (3H, d), 7.72 (3H, d), 7.61 (3H, m), 7.58 (3H, m), 7.40 (3H, t), 6.65 (3H, d), 2.18 (15H, s); ¹³C-NMR in CDCl₃-d₁: δ=151.5, 134.7, 130.5, 127.9, 126.8, 126.6, 126.2, 123.0, 121.0, 109.4, 9.7

### EXAMPLE 9

### Preparation of Cp*Ti(4-methylphenolate)₃ using Cp*Ti(OMe)₃

Cp*Ti(4-methylphenolate)₃ (in Chemical Formula 1, M is Ti, Cp is pentamethylcyclopentadienyl, n is 3, R₂, R₃, R₅, and R₆ are hydrogen, and R₄ is methyl) as an orange solid (0.78 g) was obtained at a yield (78%) by performing the same reaction method as Example 3 except that 4-methylphenol (0.69 g, 6.3 mmole) was used rather using the phenol, which was confirmed by ¹H-NMR.

¹H-NMR in CDCl₃-d₁: δ=7.06 (6H, d), 6.83 (6H, d), 2.34 (9H, s), 2.20 (15H, s); ¹³C-NMR in CDCl₃-d₁: δ=154.3, 131.0, 130.5, 130.4, 115.8, 21.3, 9.7

### EXAMPLE 10

### Preparation of Cp*Ti(4-methoxyphenolate)₃ using Cp*Ti(OiPr)₃

Cp*Ti(4-methoxyphenolate)₃ (in Chemical Formula 1, M is Ti, Cp is pentamethylcyclopentadienyl, n is 3, R₂, R₃, R₅, and R₆ are hydrogen, and R₄ is methoxy) as an orange solid (0.99 g) was obtained at a yield (90%) by performing the same reaction method as Example 4 except that 4-methoxyphenol (0.77 g, 6.3 mmole) was used rather using the phenol, which was confirmed by ¹H-NMR.

¹H-NMR in CDCl₃-d₁: δ=6.84 (12H, m), 3.83 (9H, s), 2.18 (15H, s); ¹³C-NMR in CDCl₃-d₁: δ=153.2, 149.6, 130.5, 115.7, 116.9, 55.8, 9.7

### EXAMPLE 11

### Preparation of Cp*Ti(4-N,N-dimethylaminophenolate)₃ using Cp*Ti(OiPr)₃

Cp*Ti(4-N,N-dimethylaminophenolate)₃ (in Chemical Formula 1, M is Ti, Cp is pentamethylcyclopentadienyl, n is 3, R₂ and R₃ are hydrogen, and R₅ and R₆ are (CH₂)₄) as an orange solid (1.01 g) was obtained at a yield (85%) by performing the same reaction method as Example 4 except that 4-N,N-dimethylaminophenol (0.85 g, 6.3 mmole) was used rather using the phenol, which was confirmed by ¹H-NMR.

¹H-NMR in CDCl₃-d₁: δ=6.77 (6H, d), 6.59 (6H, d), 3.06 (18H, s), 2.22 (15H, s); ¹³C-NMR in CDCl₃-d₁: δ=146.8, 143.7, 130.5, 116.8, 115.7, 41.3, 9.7

### EXAMPLE 12

### Preparation of Cp*Ti(5,6,7,8-tetrahydro-1-naphtholate)₃ using Cp*Ti(OiPr)₃

Cp*Ti(5,6,7,8-tetrahydro-1-naphtholate)₃ (in Chemical Formula 1, M is Ti, Cp is pentamethylcyclopentadienyl, n is 3, R₄, R₅, and R₆ are hydrogen, and R₂ and R₃ are linked via 1,3-butylene to form a ring) as an orange solid (0.81 g) was obtained at a yield (65%) by performing the same reaction method as Example 4 except that 5,6,7,8-tetrahydronaphthol (0.91 g, 6.2 mmole) was used rather using the phenol, which was confirmed by ¹H-NMR.

¹H-NMR in CDCl₃-d₁: δ=6.70 (3H, t), 6.48 (3H, d), 6.40 (3H, d), 2.74 (12H, t), 2.21 (15H, s), 1.72 (12H, m); ¹³C-NMR in CDCl₃-d₁: δ=158, 139, 131, 128, 127.1, 120.5, 113, 29.8, 23.0, 22.7, 9.7

### EXAMPLE 13

### Preparation of Cp*Ti(4-t-butylphenolate)₃ using Cp*Ti(OiPr)₃

Cp*Ti(4-t-butylphenolate)₃ (in Chemical Formula 1, M is Ti, Cp is pentamethylcyclopentadienyl, n is 3, R₂, R₃, R₅, and R₆ are hydrogen, and R₄ is t-butyl) as an orange solid (1.1 g) was obtained at a yield (88%) by performing the same reaction method as Example 4 except that 4-t-butylphenol (0.91 g, 6.1 mmole) was used rather using the phenol, which was confirmed by ¹H-NMR.

¹H-NMR in CDCl₃-d₁: δ=7.42 (6H, d), 6.87(6H, d), 2.2 (15H, s), 1.34 (27H, s); ¹³C-NMR in CDCl₃-d₁: δ=154.2, 144.0, 131.5, 126.4, 116.0, 31.3, 9.8

### COMPARATIVE EXAMPLE 1

### Preparation of Cp*Ti(4-t-octylphenolate)₃ using Cp*TiCl₃

(Pentamethylcyclopentadienyl)titanium(IV) trichloride (Cp*TiCl₃) (0.578 g, 1 eq.) and 4-t-octylphenol (1.238 g, 3.1 eq.) were mixed in a reaction vessel, and toluene (50 mL) was added thereto. A condenser was connected to the reaction vessel, and the reaction solution was stirred under reflux for 12 hours. When a color of the reaction solution turned from yellow to orange, Cp*Ti(4-t-octylphenolate)₃ (in Chemical Formula 1, M is Ti, Cp is pentamethylcyclopentadienyl, n is 3, and R₂, R₃, R₄, and R₆ are hydrogen, and R₄ is t-octyl) as an orange solid (0.85 g) was obtained at a yield (56%), which was confirmed by ¹H-NMR.

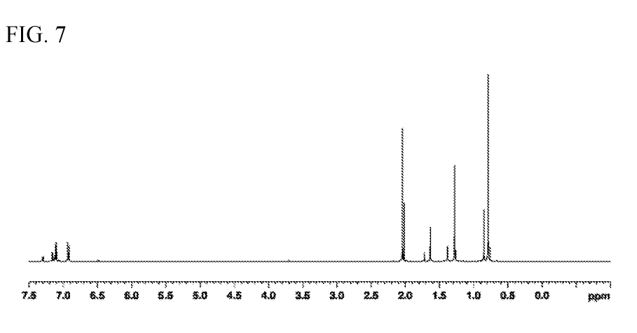

FIG. 6 illustrates ¹H-NMR data of the product, Cp*Ti(4-t-octylphenolate)₃ after the reaction of Cp*TiCl of Comparative Example 1 and 4-t-octylphenol (3.1 eq.).

### COMPARATIVE EXAMPLE 2

### Preparation of Cp*Ti(4-t-octylphenolate)₃ using Cp*TiCl₃/Et₃N

(Pentamethylcyclopentadienyl)titanium(IV) trichloride (Cp*TiCl₃) (0.578 g, 1 eq.) and 4-t-octylphenol (1.238 g, 3.1 eq.) were mixed in a reaction vessel, and toluene (50 mL) and triethylamine (0.65 g, 3.2 eq.) were added thereto. The reaction materials were mixed and stirred at room temperature for 12 hours. When a color of the reaction solution turned from yellow to orange, a triethylammonium chloride salt having a white color was produced. The triethylammonium chloride salt was removed by the filtration, and the solvent was removed to obtain Cp*Ti(4-t-octylphenolate)₃ (in Chemical Formula 1, M is Ti, Cp is pentamethylcyclopentadienyl, n is 3, and R₂, R₃, R₄, and R₆ are hydrogen, and R₄ is t-octyl) as an orange solid (0.89 g) at a yield (59%), which was confirmed by ¹H-NMR.

FIG. 7 illustrates ¹H-NMR data of the product, Cp*Ti(4-t-octylphenolate)₃ after the reaction of Cp*TiCl of Comparative Example 2, triethylamine (3.2 eq.), and 4-t-octylphenol (3.1 eq.).

### COMPARATIVE EXAMPLE 3

### Preparation of Cp*Ti(phenolate)₃ using Cp*TiCl₃

Cp*Ti(phenolate)₃ (in Chemical Formula 1, M is Ti, Cp is pentamethylcyclopentadienyl, n is 3, R₂, R₃, R₄, R₅, and R₆ are hydrogen) as an orange solid (0.48 g) was obtained at a yield (52%) by performing the same reaction method as Comparative Example 2 except that phenol (0.583 g, 3.1 eq.) was used rather using the 4-t-octylphenol, which was confirmed by ¹H-NMR.

### COMPARATIVE EXAMPLE 4

### Preparation of Cp*Ti(2,6-dimethylphenolate)₃ using Cp*TiCl₃

Cp*Ti(2,6-dimethylphenolate)₃ (in Chemical Formula 1, M is Ti, Cp is pentamethylcyclopentadienyl, n is 3, R₃, R₅, and R₄ are hydrogen, and R₂ and R₆ are methyl) as an orange solid (0.97 g) was obtained at a yield (89%) by performing the same reaction method as Comparative Example 2 except that 2,6-dimethyl phenol (0.79 g, 6.3 mmole) was used rather using phenol, which was confirmed by ¹H-NMR.

### COMPARATIVE EXAMPLE 5

### Preparation of Cp*Ti(2,6-diisopropylphenolate)₃ using Cp*TiCl₃

Cp*Ti(2,6-diisopropylphenolate)₃ (in Chemical Formula 1, M is Ti, Cp is pentamethylcyclopentadienyl, n is 3, R₃, R₅, and R₄ are hydrogen, and R₂ and R₆ are isopropyl) as an orange solid (1.33 g) was obtained at a yield (93%) by performing the same reaction method as Comparative Example 2 except that 2,6-diisopropyl phenol (1.2 g, 6.3 mmole) was used rather using phenol, which was confirmed by ¹H-NMR.

### COMPARATIVE EXAMPLE 6

### Preparation of Cp*Ti(2-phenylphenolate)₃ using Cp*TiCl₃

Cp*Ti(2-phenylphenolate)₃ (in Chemical Formula 1, M is Ti, Cp is pentamethylcyclopentadienyl, n is 3, R₃, R₄, R₅, and R₆ are hydrogen, and R₂ is phenyl) as an orange solid was obtained (0.76 g) at a yield (55%) by performing the same reaction method as Comparative Example 2 except that 2-phenyl phenol (1.12 g, 6.3 mmole) was used rather using the phenol, which was confirmed by ¹H-NMR.

### COMPARATIVE EXAMPLE 7

### Preparation of Cp*Ti(1-naphtholate)₃ using Cp*TiCl₃

Cp*Ti(1-naphtholate)₃ (in Chemical Formula 1, M is Ti, Cp is pentamethylcyclopentadienyl, n is 3, R₄, R₅, and R₆ are hydrogen, and R₂ and R₃ are linked via buta-1,3-dienylene to form a ring) as an orange solid (0.80 g) was obtained at a yield (65%) by performing the same reaction method as Comparative Example 2 except that 1-naphthol (0.89 g, 6.3 mmole) was used rather using the phenol, which was confirmed by ¹H-NMR.

### COMPARATIVE EXAMPLE 8

### Preparation of Cp*Ti(4-methylphenolate)₃ using Cp*TiCl₃

Cp*Ti(4-methylphenolate)₃ (in Chemical Formula 1, M is Ti, Cp is pentamethylcyclopentadienyl, n is 3, R₂, R₃, R₅, and R₆ are hydrogen, and R₄ is methyl) as an orange solid (0.78 g) was obtained at a yield (78%) by performing the same reaction method as Comparative Example 2 except that 4-methlyphenol (0.69 g, 6.3 mmole) was used rather using the phenol, which was confirmed by ¹H-NMR.

### COMPARATIVE EXAMPLE 9

### Preparation of Cp*Ti(4-methoxyphenolate)₃ using Cp*TiCl₃

Cp*Ti(4-methoxyphenolate)₃ (in Chemical Formula 1, M is Ti, Cp is pentamethylcyclopentadienyl, n is 3, R₂, R₃, R₅, and R₆ are hydrogen, and R₄ is methoxy) as an orange solid (0.99 g) was obtained at a yield (90%) by performing the same reaction method as Comparative Example 2 except that 4-methoxyphenol (0.77 g, 6.3 mmole) was used rather using the phenol, which was confirmed by ¹H-NMR.

### COMPARATIVE EXAMPLE 10

### Preparation of Cp*Ti(4-N,N-dimethylaminophenolate)₃ using Cp*TiCl₃

Cp*Ti(4-N,N-dimethylaminophenolate)₃ (in Chemical Formula 1, M is Ti, Cp is pentamethylcyclopentadienyl, n is 3, R₂, R₃, R₅, and R₆ are hydrogen, and R₄ is dimethylamino) as an orange solid was obtained (1.01 g) at a yield (85%) by performing the same reaction method as Comparative Example 2 except that 4-N,N-dimethylaminophenol (0.85 g, 6.3 mmole) was used rather using the phenol, which was confirmed by ¹H-NMR.

Residual chlorine contents in the products prepared by Examples and Comparative Examples were measured by ion chromatography method, and results thereof were shown in Table 1 below.

TABLE 1

| | | Purification process | | Cl content |
|---|---|---|---|---|
| | Reaction material | Sublimation | Filtration | (mg/kg) |
| Example 1 | Cp * Ti(OMe)₃ + 4-t-octylphenol | ◯ | X | Non-detected |
| Example 2 | Cp * Ti(OiPr)₃ + 4-t-octylphenol | ◯ | X | Non-detected |
| Example 3 | Cp * Ti(OMe)₃ + phenol | X | ◯ | Non-detected |
| Example 4 | Cp * Ti(OiPr)₃ + phenol | X | ◯ | Non-detected |
| Example 5 | Cp * Ti(OMe)₃ + 2,6-dimethylphenol | X | ◯ | Non-detected |
| Example 6 | Cp * Ti(OMe)₃ + 2,6-diisopropylphenol | X | ◯ | Non-detected |
| Example 7 | Cp * Ti(OMe)₃ + 2-phenylphenol | X | ◯ | Non-detected |
| Example 8 | Cp * Ti(OMe)₃ + 1-naphthol | X | ◯ | Non-detected |
| Example 9 | Cp * Ti(OMe)₃ + 4-methylphenol | X | ◯ | Non-detected |
| Example 10 | Cp * Ti(OiPr)₃ + 4-methoxyphenol | X | ◯ | Non-detected |
| Example 11 | Cp * Ti(OiPr)₃ + N,N-dimethylaminophenol | X | ◯ | Non-detected |
| Example 12 | Cp * Ti(OiPr)₃ + 5,6,7,8-tetrahydronaphthol | X | ◯ | Non-detected |
| Example 13 | Cp * Ti(OiPr)₃ + 4-t-butylphenol | X | ◯ | Non-detected |
| Comparative | Cp * TiCl₃ + 4-t-octylphenol | X | ◯ | 18 |
| Example 1 | | | | |
| Comparative | Cp * TiCl₃ + 4-t-octylphenol + triethylamine | X | ◯ | 100 |
| Example 2 | | | | |
| Comparative | Cp * TiCl₃ + phenol + triethylamine | X | ◯ | 50 |
| Example 3 | | | | |
| Comparative | Cp * TiCl₃ + 2,6-dimethylphenol + | X | ◯ | 55 |
| Example 4 | triethylamine | | | |
| Comparative | Cp * TiCl₃ + 2,6-diisopropylphenol + | X | ◯ | 58 |
| Example 5 | triethylamine | | | |
| Comparative | Cp * TiCl₃ + 2-phenylphenol + triethylamine | X | ◯ | 60 |
| Example 6 | | | | |
| Comparative | Cp * TiCl₃ + 1-naphthol + triethylamine | X | ◯ | 54 |
| Example 7 | | | | |
| Comparative | Cp * TiCl₃ + 4-methylphenol + triethylamine | X | ◯ | 60 |
| Example 8 | | | | |
| Comparative | Cp * TiCl₃ + 4-methoxyphenol + | X | ◯ | 52 |
| Example 9 | triethylamine | | | |
| Comparative | Cp * TiCl₃ + N,N-dimethylaminophenol + | X | ◯ | 49 |
| Example 10 | triethylamine | | | |

### EXAMPLES 13 TO 18 AND COMPARATIVE EXAMPLES 11 TO 12

### Measurement of Polymerization Activity

Copolymerization of ethylene and 1-octene was performed as follows, using a continuous solution polymerization reactor.

Into a stainless steel continuous polymerization reactor (1000 mL) that was sufficiently dried and purged with nitrogen, ethylene, 1-octene, modified methylaluminoxane-7 (Akzo Nobel Inc., modified MAO-7, 7 wt % Al Isopar solution) which was an aluminum co-catalyst, and trityl tetrakis(pentafluorophenyl)borate which was a boron-based co-catalyst were injected while maintaining the injection amount and the reaction temperature thereof (the catalyst injection temperature, and the reactor temperature) to be the same as each other, and then, activities of the catalysts were compared from the amount (μmole/kg) of the catalyst to be injected (hereinafter, referred to as the catalyst injection amount) using MCH as the reaction solvent, and the conversion rate of ethylene.

The injection amounts of ethylene, 1-octene, and the co-catalysts, and the residence time of the catalyst in the reactor were summarized in Table 2 below:

TABLE 2

| Items | Injection amount |
|---|---|
| Flow rate (kg/h) of total solution (MCH) | 5 |
| Injection amount of ethylene (wt %) | 10 |
| Injection ratio of 1-octene (C8/C2 ratio) | 0.19 |
| Residence time of catalyst in reactor (min) | 8 |
| Injection amount of ethylene (g/h) | 500 |
| Injection amount of 1-octene (g/h) | 95 |
| Injection amount of aluminum co-catalyst | 280 |
| (μmole/kg) | |
| Injection amount of boron-based co-catalyst | 56 |
| (μmole/kg) | |

Cp*Ti(4-t-octylphenolate)_{3,} Cp*Ti(2-phenylphenolate)₃, Cp*Ti(4-t-butylphenolate)₃, and Cp*Ti(4-t-octylphenolate)₃ synthesized by Examples 1, 7, 13 and Comparative Example 2, were prepared into toluene solutions (1 mM), respectively, and the respective toluene solutions were injected into the continuous solution polymerization reactor, and then, ethylene was continuously supplied in the reactor to induce the polymerization. The injection amount of MCH solvent was controlled so that the residence time of the catalyst in the reactor proceeded for 8 minutes, and the catalyst injection amount was measured while constantly maintaining the catalyst injection temperature and the reactor temperature. The conversion rate of ethylene was measured by measuring a weight of the polymer to be produced, and represented by a ratio of the weight of the polymer with regard to the ethylene injection amount.

The density, the molecular weight (MI), the conversion rate, and the catalyst injection amount of the polymers prepared at the catalyst injection temperature of 60° C. and the reactor temperature of 150° C. were summarized in Table 3 below.

TABLE 3

| | | | | Comparative |
|---|---|---|---|---|
| | Example 13 | Example 14 | Example 15 | Example 11 |
| Catalyst | Cp * Ti(4-t- | Cp * Ti(2- | Cp * Ti(4-t- | Cp * Ti(4-t- |
| | octylphenolate)₃ | phenylphenolate)₃ | butylphenolate)₃ | octylphenolate)₃ |
| | prepared by | prepared by | prepared by | prepared by |
| | Example 1 | Example 7 | Example 13 | Comparative |
| | | | | Example 2 |
| MI | 13.38 | 3.24 | 14.85 | 8.36 |
| Density (g/cc) | 0.9127 | 0.9136 | 0.9145 | 0.9118 |
| Catalyst Injection | 5.5 | 5.5 | 5.5 | 9.5 |
| amount | | | | |
| (μmole/kg) | | | | |
| Catalyst Injection | 60 | 60 | 60 | 60 |
| temperature | | | | |
| (° C.) | | | | |
| Reactor | 150 | 150 | 150 | 150 |
| temperature | | | | |
| (° C.) | | | | |
| Conversion rate | 100 | 99 | 100 | 98 |
| (%) | | | | |

1) Melt Index: measured according to ASTM D 2839.
2) Density: measured by using a density-gradient tube according to ASTM D 1505.

In addition, the density, the molecular weight (MI), the conversion rate, and the catalyst injection amount of the polymers prepared at the catalyst injection temperature of 70° C. and the reactor temperature of 160° C. were summarized in Table 4 below.

TABLE 4

| | | | | Comparative |
|---|---|---|---|---|
| | Example 16 | Example 17 | Example 18 | Example 12 |
| Catalyst | Cp * Ti(4-t- | Cp * Ti(2- | Cp * Ti(4-t- | Cp * Ti(4-t- |
| | octylphenolate)₃ | phenylphenolate)₃ | butylphenolate)₃ | octylphenolate)₃ |
| | prepared by | prepared by | prepared by | prepared by |
| | Example 1 | Example 7 | Example 13 | Comparative |
| | | | | Example 2 |
| MI | 0.57 | 1.06 | 0.55 | 0.55 |
| Density (g/cc) | 0.9141 | 0.9176 | 0.9167 | 0.9150 |
| Catalyst Injection | 4.6 | 5.9 | 4.3 | 9 |
| amount | | | | |
| (μmole/kg) | | | | |
| Catalyst Injection | 70 | 70 | 70 | 70 |
| temperature | | | | |
| (° C.) | | | | |
| Reactor | 160 | 160 | 160 | 160 |
| temperature | | | | |
| (° C.) | | | | |
| Conversion rate | 89 | 89 | 91 | 93 |
| (%) | | | | |

1) Melt Index: measured according to ASTM D 2839.
2) Density: measured by using a density-gradient tube according to ASTM D 1505.

As appreciated in Tables 3 and 4, the catalyst injection amounts of the catalyst compounds of Examples 13 to 18 at the polymerization temperature of 150° C. and 160° C. were smaller than those of the catalyst compounds of Comparative Examples 11 and 12. Specifically, it could be appreciated that in preparing the polymers having the same amount, the catalyst compounds prepared by the synthesis method excluding Cl ion had a high activity, that is, a small amount of catalyst injection as compared to those synthesized by the preparation method including the Cl ion. The catalyst compounds of Examples of the present invention had the characteristic in which the catalyst injection amount was small, i.e., the high polymerization activity, which resulted from the method for preparing the catalyst. In the catalyst compounds of Comparative Examples, the triethylammonium chloride salt including Cl ion was present in the catalyst compound, which could have an effect on the polymerization activity.

In particular, it could be appreciated that in Examples 13 to 18 using the catalyst prepared from the transition metal alkoxide precursor and purified by the sublimation or the filtration according to the present invention, the impurities in the catalyst compounds could be easily removed, such that the catalytic activity was relatively high, as compared to Comparative Examples 11 and 12 using the catalyst prepared from the existing transition metal chloride precursor.

Further, the catalyst of Comparative Examples 2 used in Comparative Examples 11 and 12 was a catalyst prepared from the transition metal chloride precursor, wherein the chloride caused from the starting material remained in the catalyst, which had problems in that corrosion of the material of the reactor, etc., used in the polymerization process occurred, catalyst deformation materials that are impurities were formed, and it was difficult to precisely control the polymerization reaction since precise injection of the catalyst was difficult to perform.

### INDUSTRIAL APPLICABILITY

The method for preparing a transition metal complex according to the present invention includes reacting a transition metal alkoxide precursor that does not include a halogen, particularly, chlorine, as the starting material, and a phenolic ligand capable of being purified by sublimation or a simple filtration, thereby preparing the transition metal complex at a high yield, and thus, formation of denatured species due to moisture which is a problem according to the related art may be minimized, and simultaneously, the prepared transition metal complex and unreacted phenolic ligand may be simply separated through purification by the sublimation or the simple filtration.

In addition, since the halogen, particularly, chlorine, is not included at all in the process of preparing the transition metal complex, there is no concern about the corrosion of a material during the process even though the prepared transition metal complex is used for olefin polymerization. Further, a transition metal chloride precursor which is a starting material used in the related art has a problem in that a product and an amine residue coexist since the transition metal chloride precursor is necessarily used together with an amine-based compound. However, the present invention using the transition metal alkoxide precursor which is not chloride, as the starting material, has an advantage in that impurities such as the amine residue do not coexist with the product.

Further, the present invention has a good reaction selectivity, such that the transition metal complex combined with 1, 2, or 3 phenolic ligand(s) is capable of being easily prepared only by a change in a molar ratio of reaction materials.

1. A method for preparing a transition metal complex represented by Chemical Formula 1 below:
reacting a transition metal alkoxide precursor represented by Chemical Formula 2 below and a phenolic ligand represented by Chemical Formula 3 below: 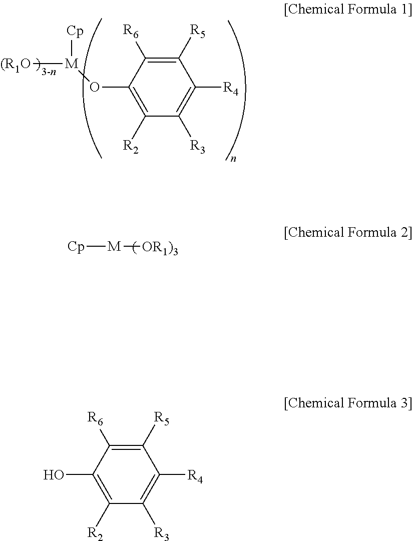
in Chemical Formulas 1, 2, and 3,
M is a transition metal of Group 4 in the periodic table;
Cp is a cyclopentadienyl ring which is a η5-bond to M, or a fused ring containing the cyclopentadienyl ring, the cyclopentadienyl ring or the fused ring containing the cyclopentadienyl ring may be further substituted with one or more selected from (C1-C20)alkyl, (C6-C30)aryl, (C2-C20)alkenyl, and (C6-C30)aryl(C1-C20)alkyl;
R₁ is (C1-C20)alkyl;
R₂, R₃, R₄, R₅, and R₆ are each independently hydrogen, halogen, (C1-C30)alkyl, (C6-C30)aryl, (C6-C30)aryl(C1-C30)alkyl, (C1-C30)alkyl(C6-C30)aryl, (C1-C30)alkoxy, (C6-C30)aryloxy or NR′R″, or R₂ and R₃ or R₅ and R₆ may be linked via (C2-C6)alkylene or (C2-C6)alkenylene to form a fused ring, respectively;
R′ and R″ are each independently (C1-C30)alkyl or (C6-C30)aryl; and
n is an integer of 1 to 3.

2. The method of claim 1, wherein the reaction is performed under a solvent selected from the group consisting of methylcyclohexane (MCH), hexane, methylene dichloride, toluene, cyclohexane, benzene and heptane, or is performed under vacuum.

3. The method of claim 2, wherein the reaction is performed at a reflux temperature of the solvent.

4. The method of claim 1, wherein a molar ratio of the transition metal alkoxide precursor represented by Chemical Formula 2 and the phenolic ligand represented by Chemical Formula 3 is 1 : 1.1 to 3.5.

5. The method of claim 1, wherein R₂, R₃, R₅, and R₆ are each independently hydrogen, halogen, (C1-C30)alkyl, (C6-C30)aryl, or R₂ and R₃, or R₅ and R₆ may be linked via (C2-C6)alkylene or (C2-C6)alkenylene to form a fused ring, respectively; R₄ is hydrogen, halogen, (C1-C30)alkyl, (C1-C30)alkoxy, (C6-C30)aryloxy or NR′R″; and R′ and R″ are each independently (C1-C30)alkyl or (C6-C30)aryl.

6. The method of claim 5, wherein a transition metal complex represented by Chemical Formula 4 below is prepared by reacting the transition metal alkoxide precursor represented by Chemical Formula 2 below and the phenolic ligand represented by Chemical Formula 3 below: 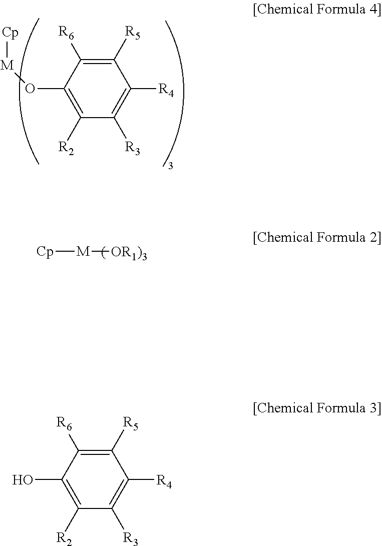
in Chemical Formulas 2, 3, and 4,
M is a transition metal of Group 4 in the periodic table;
Cp is a cyclopentadienyl ring which is a η5-bond to M, or a fused ring containing the cyclopentadienyl ring, the cyclopentadienyl ring or the fused ring containing the cyclopentadienyl ring may be further substituted with one or more selected from (C1-C20)alkyl, (C6-C30)aryl, (C2-C20)alkenyl, and (C6-C30)aryl(C1-C20)alkyl;
R₁ is (C1-C20)alkyl;
R₂ and R₆ are each independently hydrogen, halogen, (C1-C20)alkyl or (C6-C20)aryl;
R₃ and R₅ are each independently hydrogen or halogen;
R₂ and R₃, or R₅ and R₆ may be linked via (C2-C6)alkylene or (C2-C6)alkenylene to form a fused ring; and
R₄ is hydrogen, halogen, (C1-C20)alkyl, (C1-C20)alkoxy, or di(C1-C20)alkylamino.

7. The method of claim 6, wherein a molar ratio of the transition metal alkoxide precursor represented by Chemical Formula 2 and the phenolic ligand represented by Chemical Formula 3 is 1:3.0 to 3.5.

8. The method of claim 6, wherein the transition metal complex represented by Chemical Formula 4 is selected from the following structures:

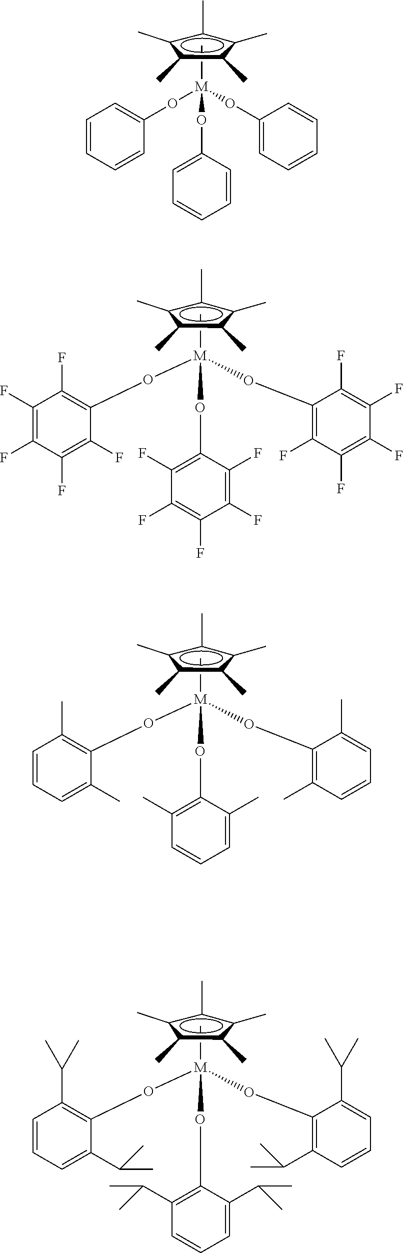

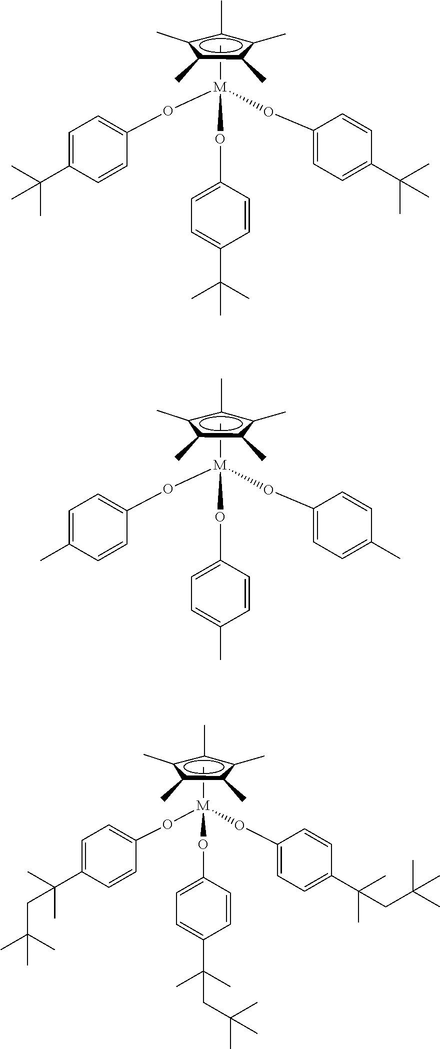

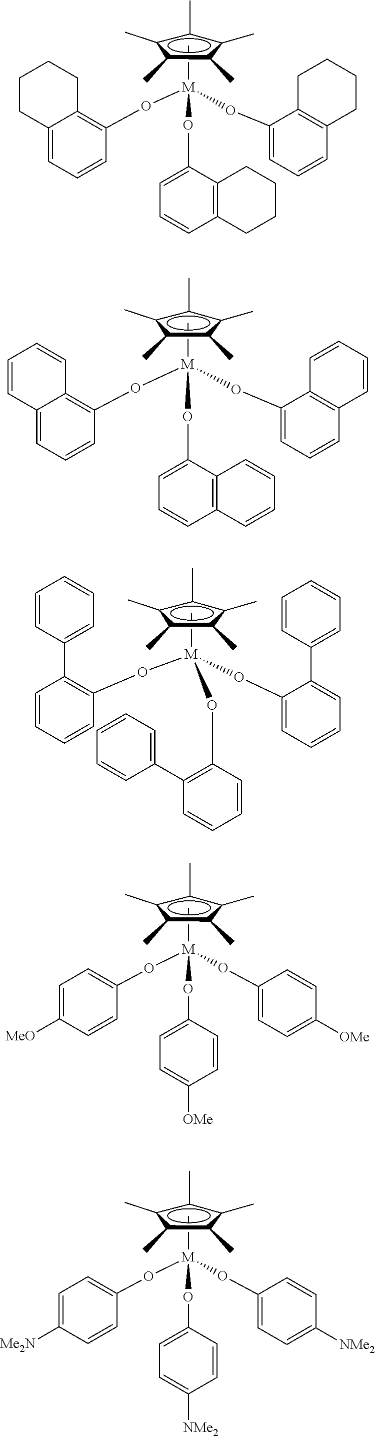

9. The method of claim 1, further comprising:
purification by sublimation after the reaction.
